(19) United States
(12) Patent Application Publication
(10) Pub. No.: US 2019/0169853 A1
(43) Pub. Date: Jun. 6, 2019

(54) RETRACTABLE SHADE SYSTEM HAVING FLEXIBLE SOLAR PANEL

(71) Applicant: Hoon BAI, Torrance, CA (US)

(72) Inventor: Hoon BAI, Torrance, CA (US)

(21) Appl. No.: 16/211,137

(22) Filed: Dec. 5, 2018

Related U.S. Application Data
(60) Provisional application No. 62/594,678, filed on Dec. 5, 2017.

(51) Int. Cl. E04F 10/06; E04F 10/10; H02S 30/20; F21S 9/03

(52) U.S. Cl. CPC E04F 10/0611; E04F 10/10; F21S 9/032; E04F 10/0607; H02S 30/20; E04F 10/0666

(57) ABSTRACT

A retractable shade system is provided, comprising a base material, a first horizontal pole, a prop, and a retractable solar panel. The base material has a first end portion, a second end portion, and two side portions, wherein the first end portion is configured to be fixed to an anchoring object, so that the base material is disposed by a specific angle with respect to the anchoring object. The first horizontal pole is disposed at the second end portion of the base material. The prop is installed between the base material and the anchoring object, so that the retractable shade system is disposed with respect to the anchoring object in a stable condition. The retractable solar panel is disposed at the base material and configured to be deployed or retracted toward the first end portion of the base material.

### RELATED APPLICATION

This application is a Non-provisional application of Provisional Application Ser. No. 62/594,678 for “RETRACTABLE SHADE SYSTEM HAVING FLEXIBLE SOLAR PANEL” filed on Dec. 5, 2017.

### BACKGROUND OF THE INVENTION

The present invention relates to a retractable shade system having flexible solar panel.

The demand for energy keeps to increase due to fast industrial development and population increase. Also, the coming depletion of fossil fuel makes it urgent to develop alternative energy. Various types of natural disasters keep increasing for the global warming caused by air pollution and the like.

Therefore, governments and enterprises support developing renewable energy including solar power, wind power, tidal power, etc.

Accordingly, a need for a retractable shade system having flexible solar panel has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a retractable shade system having flexible solar panel.

An aspect of the invention provides a retractable shade system, comprising a base material, a first horizontal pole, a prop, and a retractable solar panel.

The base material of a rectangular shape has a first end portion, a second end portion, and two side portions, wherein the first end portion is configured to be fixed to an anchoring object, so that the base material is disposed by a specific angle with respect to the anchoring object.

The first horizontal pole is disposed at the first end portion of the base material.

The prop is installed between the base material and the anchoring object, so that the retractable shade system is disposed with respect to the anchoring object in a stable condition.

The retractable solar panel is disposed at the base material and configured to be deployed or retracted toward the first end portion of the base material.

The retractable shade system may further comprise a second horizontal pole disposed between the second end portion of the base material and the anchoring object.

The base material may comprise a sunshade. The retractable solar panel may be disposed on a top of the sunshade.

The prop may comprise a first prop portion and a second prop portion that are connected by a joint, so as to be folded so that the sunshade and the retractable solar panel are folded on the anchoring object.

The base material may comprise a frame formed with a perimeter portion and one or more horizontal and vertical bar portions.

The retractable solar panel may be disposed on a bottom side of the frame.

The retractable shade system may further comprise a winding cylinder disposed at the first end portion of the base material, so that the retractable solar panel engages the winding cylinder and is configured to be retracted into the winding cylinder or deployed out of the winding cylinder.

The base material may comprise a frame formed with a perimeter portion and one or more horizontal and vertical bar portions, and the retractable solar panel may be disposed on a bottom side of the frame. Also, the retractable shade system may further comprise a plurality of light lamps attached to the bottom side of the retractable solar panel, and the plurality of light lamps are powered by electricity from the retractable solar panel.

The prop may comprise a right prop portion and a left prop portion that are disposed to the two side portions of the base material, and each of the right and left prop portions may comprise a first end portion and a second end portion, and the first end portion is fixed to the first horizontal pole and the second end portion is fixed to the anchoring object perpendicularly.

The base material may comprise a frame formed with a perimeter portion and one or more horizontal and vertical bar portions, and the retractable solar panel may be disposed on a bottom side of the frame. And the retractable shade system may further comprise a plurality of rings, each of which being attached to a top side of the retractable solar panel and queued to a corresponding vertical bar portion of the frame so as to slide along the corresponding vertical bar portion.

The anchoring object may comprise a wall, and wherein the specific angle is between zero (0) and ninety (90) degrees.

The advantages of the present invention are: (1) the retractable shade system having flexible solar panel according to the invention enables to achieve another goals while producing solar power; and (2) the retractable shade system having flexible solar panel provides each deployment.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a side view showing a retractable shade system having flexible solar panel according to an embodiment.

FIG. 2 is a side view showing a retractable shade system having flexible solar panel installed in a winding drum according to another embodiment.

FIG. 3 is a side view showing a retractable shade system having flexible solar panel installed on a sail frame according to still another embodiment.

FIG. 4 is a side view showing a retractable shade system having flexible solar panel according to still another embodiment.

FIG. 5 is a side view showing a retractable shade system having flexible solar panel installed in a winding drum according to still another embodiment.

FIG. 6 is a side view showing a retractable shade system having flexible solar panel installed on a sail frame according to still another embodiment.

FIG. 7 is a top plan view showing a base material and horizontal poles according to an embodiment.

FIG. 8 is a top plan view showing aa base material according to another embodiment.

### DETAILED DESCRIPTION EMBODIMENTS OF THE INVENTION

The U.S. Provisional Application Ser. No. 62/594,678 for “RETRACTABLE SHADE SYSTEM HAVING FLEXIBLE SOLAR PANEL” filed on Dec. 5, 2017, is incorporated by reference herein for any and all purposes.

Referring to the figures, the embodiments of the invention are described in detail.

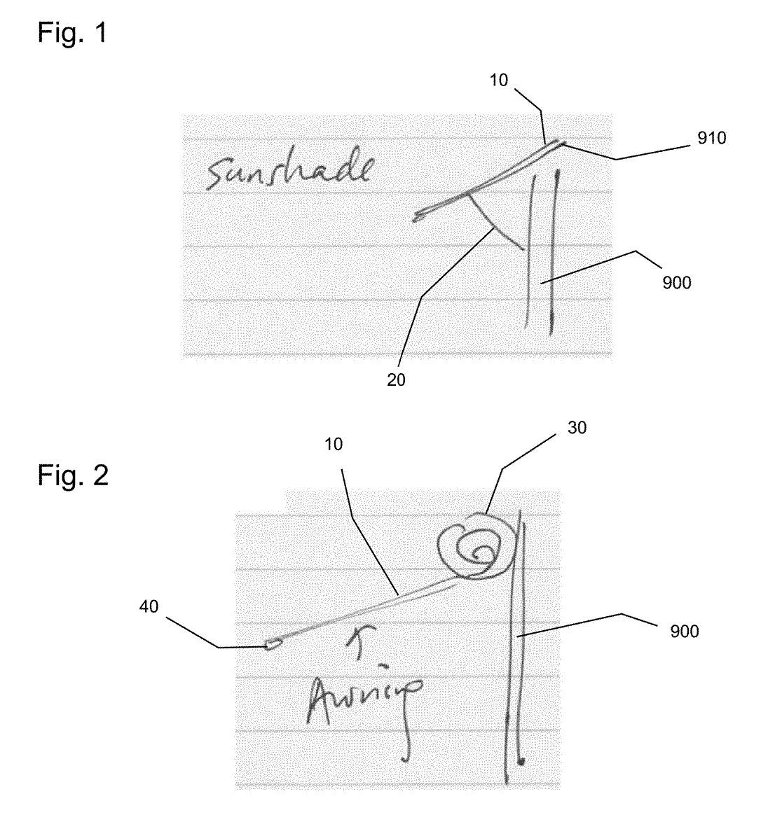

The invention provides a retractable shade system having flexible solar panel installed on a base material as shown in FIGS. 1 and 4.

The flexible solar panel (10) may be installed on a top surface of a base material (910) such as a regular sunshade or a frame as shown in FIG. 1. One or two sides of the flexible solar panel (10) may be secured to one or two poles (40), facilitating the flexible solar panel (10) to be deployed flatly. One of the poles (40) may be fixed on a wall (900) by a fixture (932) such as bolt and nut or clamps as shown in FIG. 4. Also, the structure of the flexible solar panel (10) and the base material (910) may be propped with a stick or a prop (940).

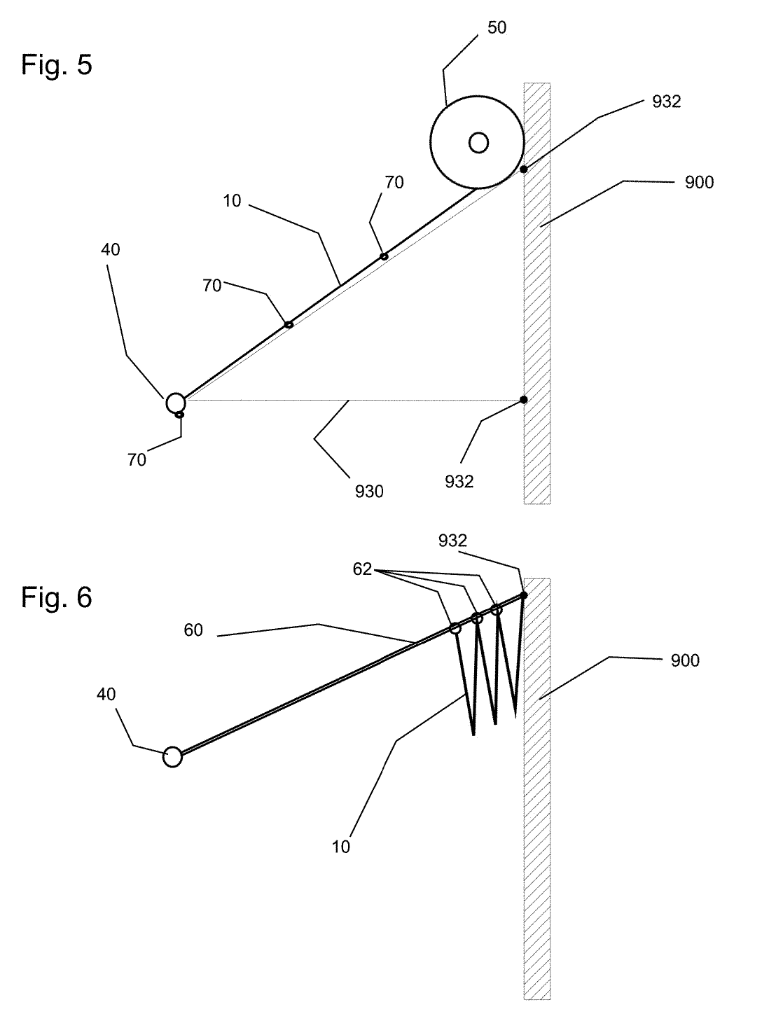

The invention provides a tractable shade system with a flexible solar panel installed in a winding cylinder as shown in FIGS. 2 and 5.

The flexible solar panel (10) may be installed in a winding cylinder (30) retractably. Also, a pole (40) may be disposed at a side edge portion of the flexible solar panel (10) (and a base sheet like the base material (20) as shown in FIG. 2. And the winding cylinder (50) may be attached to the wall (900) through its own fixture (not shown). Additionally, a frame (930) may be further provided under the flexible solar panel (10), the winding cylinder (50), and the pole (40), so as to support them for underneath. The frame (930) may be attached to the wall through the fixtures (932) as shown in FIG. 5.

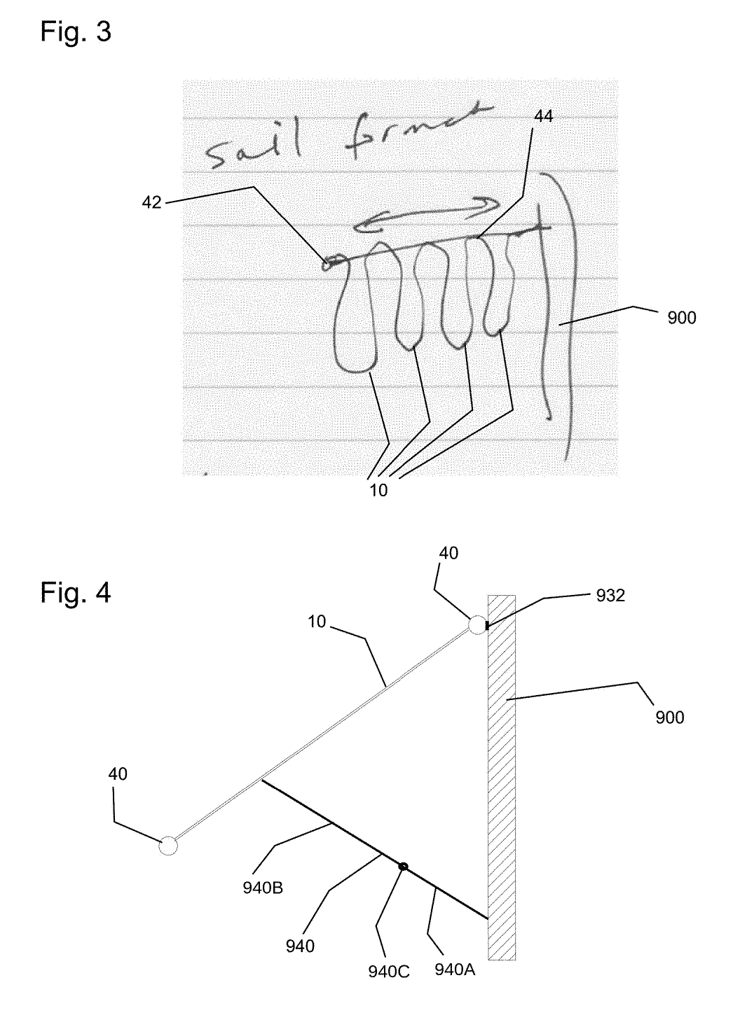

The invention provides a retractable shade system with a flexible solar panel hooked on a steel wire so as to be deployed or folded as shown in FIGS. 3 and 6.

In certain embodiments, the flexible solar panel (10) may be hooked to a sail frame (44) slidably. The sail frame (44) may be extendable in a telescopic matter. The sail frame (44) may have an end portion (42) to which the flexible solar panel (10) is fixed as shown in FIG. 3. Alternatively, the flexible solar panel (10) may be hooked to rings (62) and draped from the sail frame (60) slidably as shown in FIG. 6. The sail frame (60) may be fixed to the wall (900) through one or more fixture (932).

The retractable shade system having flexible solar panel, cells, or sheet along with a retractable system can be used for providing a shade in various settings such as house, building, parking lot, road, etc. Since it is retractable, the system can save lots of space.

It can be made in many different colors for landscaping purposes.

Furthermore, the retractable shade system having flexible solar panel may further comprise a plurality of lights (70) including LEDs disposed along the edge of the flexible solar panel (10) or around it, and the lights can be powered by the electricity generated by the flexible solar panel, which can be used as street lights or for decoration as shown in FIG. 5.

In certain embodiments of the invention, the retractable shade system having flexible solar panel may further comprise a battery (not shown) for storing the electric power generated by the flexible solar panel (10).

An aspect of the invention provides a retractable shade system, comprising a base material (910), a first horizontal pole (40), a prop (20, 940), and a retractable solar panel (10) as shown in FIGS. 1-8.

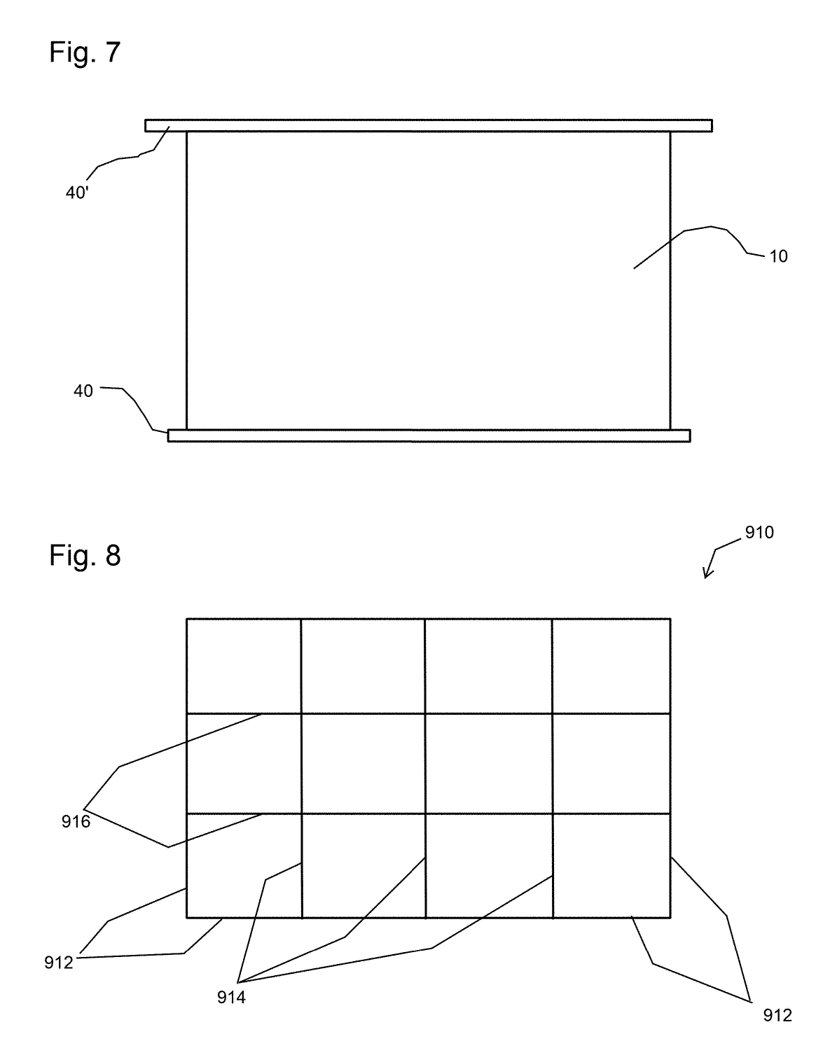

The base material (910) of a rectangular shape has a first end portion (fixed to the element (40′) at the bottom side thereof in FIG. 7), a second end portion (fixed to the element (40) at the top side thereof in FIG. 7), and two side portions (disposed on the right and left side of element (10)), and the first end portion is configured to be fixed to an anchoring object (900), so that the base material (910) is disposed by a specific angle with respect to the anchoring object (900). The anchoring object (900) may be a wall or vertical structure as illustrated in FIG. 5.

The first horizontal pole (40) is disposed at the first end portion of the base material (910) as shown in FIGS. 4 through 7. Mechanically, the base material (910) and the anchoring object (900) may be formed integrally. Furthermore, the first horizontal pole (40) may be formed integrally also with the base material (910) and the anchoring object (900).

The prop (20, 940) is installed between the base material (910) and the anchoring object (900), so that the retractable shade system is disposed with respect to the anchoring object (900) in a stable condition. In certain embodiment, the prop may be provided in a form of frame (930) as shown in FIG. 5. That is, the prop (20, 940) may meet with the anchoring object (900) or the base material (910) with any appropriate angle, as long as the retractable shade system is kept is a static and dynamic equilibrium mechanically.

The retractable solar panel (10) is disposed at the base material (910) and configured to be deployed or retracted toward the first end portion of the base material (910) as shown in FIGS. 5 ad 6. The retractable solar panel (10) may be disposed on the top or bottom of the base material (910) as long as the base material (910) does not interfere the movements of the retractable solar panel (10).

The retractable shade system may further comprise a second horizontal pole (40′) disposed between the second end portion of the base material (910) and the anchoring object (900) as shown in FIGS. 4 and 7.

The base material (910) may comprise a sunshade. The sunshade may be the base material (910) itself or may be provided in a form of sheet on top of the base material (910). The retractable solar panel (10) may be disposed on a top of the sunshade. For example, the base material (910) may have substantially same area and shape as the retractable solar panel (10) as shown in FIG. 7. That is, the base material (910) or the sunshade may be disposed right below the illustrated retractable solar panel (10) in FIG. 7.

As shown in FIG. 4, the prop (20, 940) may comprise a first prop portion (940A) and a second prop portion (940B) that are connected by a joint (940C), so as to be folded so that the sunshade and the retractable solar panel (10) are folded on or over the anchoring object (900) vertically.

The base material (910) may comprise a frame formed with a perimeter portion (912) and one or more horizontal and vertical bar portions (914, 916) as shown in FIG. 8.

The retractable solar panel (10) may be disposed on a bottom side of the frame (910) as shown in FIGS. 3, 6, and 8.

The retractable shade system may further comprise a winding cylinder (50) disposed at the first end portion of the base material (910), so that the retractable solar panel (10) engages the winding cylinder (50) and is configured to be retracted into the winding cylinder (50) or deployed out of the winding cylinder (50) as shown in FIGS. 2 and 5.

The base material (910) may comprise a frame formed with a perimeter portion (912) and one or more horizontal and vertical bar portions (914, 916), and the retractable solar panel (10) may be disposed on a bottom side of the frame (910). Also, the retractable shade system may further comprise a plurality of light lamps (70) attached to the bottom side of the retractable solar panel (10), and the plurality of light lamps (70) may be powered by electricity from the retractable solar panel (10) as shown in FIG. 5.

The prop (20, 940) may comprise a right prop portion and a left prop portion that are disposed along the right and left side of the two side portions of the base material (910) respectively, and each of the right and left prop portions may comprise a first end portion and a second end portion, and the first end portion is fixed to the first horizontal pole (40) and the second end portion is fixed to the anchoring object (900) perpendicularly. This can be visualized by increasing the viewing dimension from FIGS. 1, 4, and 5 to FIG. 7. In certain embodiments, the number of prop (20, 940) may be one or more than two, obviously.

The base material (910) may comprise a frame formed with a perimeter portion (912) and one or more horizontal and vertical bar portions (914, 916), and the retractable solar panel (10) may be disposed on a bottom side of the frame (910) shown in FIG. 8. And the retractable shade system may further comprise a plurality of rings (62), each of which being attached to a top side of the retractable solar panel (10) and queued to a corresponding vertical bar portion of the frame (910) so as to slide along the corresponding vertical bar portion as shown in FIGS. 6 and 8.

The anchoring object (900) may comprise a wall, and the specific angle with respect to the base material (910) may be between zero (0) and ninety (90) degrees.

In certain embodiments, the first horizontal pole (40) may be fixed to the first edge portion of the retractable solar panel (10), so as to work as a weight for deploying the solar panel easily.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A retractable shade system comprising:
a base material of a rectangular shape having a first end portion, a second end portion, and two side portions, wherein the first end portion is configured to be fixed to an anchoring object, so that the base material is disposed by a specific angle with respect to the anchoring object;
a first horizontal pole disposed at the first end portion of the base material;
a prop installed between the base material and the anchoring object, so that the retractable shade system is disposed with respect to the anchoring object in a stable condition; and
a retractable solar panel disposed at the base material and configured to be deployed or retracted toward the first end portion of the base material.

2. The retractable shade system of claim 1, further comprising a second horizontal pole disposed between the second end portion of the base material and the anchoring object.

3. The retractable shade system of claim 1, wherein the base material comprises a sunshade.

4. The retractable shade system of claim 3, wherein the retractable solar panel is disposed on a top of the sunshade.

5. The retractable shade system of claim 3, wherein the prop comprises a first prop portion and a second prop portion that are connected by a joint, so as to be folded so that the sunshade and the retractable solar panel are folded on the anchoring object.

6. The retractable shade system of claim 1, wherein the base material comprises a frame formed with a perimeter portion and one or more horizontal and vertical bar portions.

7. The retractable shade system of claim 6, wherein the retractable solar panel is disposed on a bottom side of the frame.

8. The retractable shade system of claim 1, further comprising a winding cylinder disposed at the first end portion of the base material, so that the retractable solar panel engages the winding cylinder and is configured to be retracted into the winding cylinder or deployed out of the winding cylinder.

9. The retractable shade system of claim 1, wherein the base material comprises a frame formed with a perimeter portion and one or more horizontal and vertical bar portions,
wherein the retractable solar panel is disposed on a bottom side of the frame, and
further comprising a plurality of light lamps attached to the bottom side of the retractable solar panel, wherein the plurality of light lamps are powered by electricity from the retractable solar panel.

10. The retractable shade system of claim 1, wherein the prop comprises a right prop portion and a left prop portion that are disposed to the two side portions of the base material, and each of the right and left prop portions comprises a first end portion and a second end portion, wherein the first end portion is fixed to the first horizontal pole and the second end portion is fixed to the anchoring object perpendicularly.

11. The retractable shade system of claim 1, wherein the base material comprises a frame formed with a perimeter portion and one or more horizontal and vertical bar portions, wherein the retractable solar panel is disposed on a bottom side of the frame, and
further comprising a plurality of rings, each of which being attached to a top side of the retractable solar panel and queued to a corresponding vertical bar portion of the frame so as to slide along the corresponding vertical bar portion.

12. The retractable shade system of claim 1, wherein the anchoring object comprises a wall, and wherein the specific angle is between zero (0) and ninety (90) degrees.
